(19) United States
(12) Patent Application Publication
(10) Pub. No.: US 2018/0067202 A1
(43) Pub. Date: Mar. 8, 2018

(54) METHOD OF DETERMINING A DISTANCE BETWEEN AN ACTIVE AND A PASSIVE RADIO COMMUNICATION UNIT

(71) Applicant: Marantec Antriebs- und Steuerungstechnik GmbH & Co. KG, Marienfeld (DE)

(72) Inventor: Michael HOERMANN, Halle/Westf. (DE)

(21) Appl. No.: 15/695,329

(22) Filed: Sep. 5, 2017

(30) Foreign Application Priority Data
Sep. 6, 2016 (DE) 10 2016 010 745.6

(51) Int. Cl. G01S 13/32; H04W 4/00; G07C 9/00

(52) U.S. Cl. CPC G01S 13/32; G07C 9/00309; H04W 4/008

(57) ABSTRACT

The present disclosure relates to a method of determining a distance between an active radio communication unit and a passive radio communication unit, wherein, a constant electromagnetic field is generated by the active radio communication unit and on an entry of the passive radio communication unit into the electromagnetic field, the passive radio communication unit withdraws power from the electromagnetic field and a control variable acting on the electromagnetic field is readjusted in the active passive radio communication unit, and wherein the distance of the two radio communication units from one another is determined using the readjusted control variable.

### CROSS REFERENCE TO RELATED APPLICATION

This application claims priority to German Patent Application No. 10 2016 010 745.6, entitled “Method of Determining a Distance Between an Active and a Passive Radio Communication Unit,” filed on Sep. 6, 2016, the entire contents of which is hereby incorporated by reference in its entirety for all purposes.

### TECHNICAL FIELD

The present disclosure relates to a method of determining a physical distance between an active radio communication unit and a passive radio communication unit.

### BACKGROUND AND SUMMARY

It can be of advantage for specific applications if the distance between two radio communication units can be determined. It is thus possible, for example, to have different functions carried out in dependence on the distance between the two radio communication units.

A constant electromagnetic field is generated by the active radio communication unit wherein on an entry of the passive radio communication unit into the electromagnetic field, the passive radio communication unit withdraws power from the electromagnetic field, a control variable (current, voltage) acting on the electromagnetic field is readjusted in the active radio communication unit and the distance of the two radio communication units from one another is determined using the readjusted control variable. For example, the electromagnetic field may be readjusted by keeping the control variable constant.

The above-described method serves the determination of the distance by the active radio communication unit. A control variable (e.g. current, voltage) acting on the power of the electromagnetic field is readjusted in said active radio communication unit to maintain the constant electromagnetic field that is provided by the active radio communication unit. A conclusion can be drawn on the distance between the active radio communication unit and the passive radio communication unit from the power withdrawal from the electromagnetic field by the passive radio communication unit. As the power withdrawal increases, the smaller the distance from the active unit becomes.

Alternatively, the distance between the two radio communication units may be determined on the side of the passive radio communication unit. The same principle is made use of in this process as in the above-described methods.

On the entry of the passive radio communication unit into the electromagnetic field, power induced via the electromagnetic field of the passive radio communication unit is detected in the passive radio communication unit, with the spacing of the two radio communication units from one another being determined with reference to the induced power. If the passive radio communication unit enters into the electromagnetic field of the active radio communication unit, a reduction in the distance of the two units will result, preferably with mutually matching orientations of the two radio communication units, in an increase in the power consumption of the passive radio communication unit. This effect is used to determine the distance between the two radio communication units.

In accordance with another embodiment, the passive radio communication unit may have constant power consumption or variable power consumption.

The passive radio communication unit preferably comprises an antenna or a coil for the power consumption from the electromagnetic field. The antenna or the coil of the passive radio communication unit is used to supply a consumer of the passive radio communication unit connected to the antenna or coil with energy. The energy is in this respect preferably taken from the electromagnetic field.

In one embodiment, the induced power is measured and compared with at least one threshold value, with the passive radio communication unit preferably carrying out a function such as, but not limited to, preparing the circuits for opening the door soon, initiating a downstream system, supplying a downstream system with the power and the like, in dependence on the comparison with the at least one threshold.

Provision can thus be made that a specific function is carried out on a falling below of a specific distance between the active and passive radio communication units.

In accordance with one embodiment, the measured power is compared with a plurality of threshold values dividing a power range and the passive radio communication unit carries out a function linked to a power range when the measured power is in the corresponding power range. In this respect, each of the power ranges divided by the voltage values is linked to a respective function, the functions being able to be different from one another. It is therefore possible to carry out functions dependent on the distance of the two radio communication units so that a first function is carried out at a first specific distance range and a second function is carried out at a second specific distance range that the active and passive radio communication units adopt to one another.

In accordance with a further embodiment, the active radio communication unit generates an electromagnetic field having a constant voltage, with said electromagnetic field being readjusted on an entry of the passive radio communication unit into the field so that the voltage regulation produces a value that continuously reproduces the distance between the two radio communication units. The electromagnetic field can thus, for example, be generated with a constant voltage that has to be readjusted on an entry of the passive radio communication unit into the electromagnetic field produced by the active radio communication unit. The degree of the required readjustment for a holding constant of the voltage is directly related to the distance that the passive radio communication unit has from the active radio communication unit. A high degree of voltage readjustment is associated with a small distance of the passive radio communication unit from the active radio communication unit, whereas a small voltage readjustment is associated with a further remote distance between the two radio communication units.

In accordance with a further optional embodiment of the present disclosure, the readjusted voltage is measured and compared with at least one threshold value, with the active radio communication unit preferably carrying out a function in dependence on the comparison with the at least one threshold value.

It is also possible that the readjusted voltage is compared with a plurality of threshold values dividing a voltage range. The active radio communication unit carries out a function linked to a respective voltage range when the readjusted voltage is in the corresponding voltage range.

In accordance with an additional preferred embodiment of the present disclosure, the passive radio communication unit and the active radio communication unit can set up a Near Field Communication (NFC) connection or a radio-frequency identification (RFID) connection between one another.

It is preferably possible by the setting up of an NFC connection or an RFID connection that information is transmitted from the passive radio communication unit to the active radio communication unit and/or information is transmitted from the active radio communication unit to the passive radio communication unit.

The active radio communication unit is preferably an NFC reader/writer which reads information stored on NFC tags and the passive radio communication unit is an NFC tag comprising storage memory and a radiochip with an attached antenna.

The present disclosure furthermore comprises a method of actuating a door, wherein the distance measurement of the two radio communication units is carried out in the method in accordance with one of the above-listed methods and a downstream system that is associated with the active radio communication unit or with the passive radio communication unit and that can instigate an actuation of a door is activated on a falling below of a specific distance threshold value.

The downstream system is preferably a radio module to actuate the door. The door can in particular be a garage door to close a garage or an access gate.

Further details, features and advantages of the present disclosure will become evident with reference to the description of the FIGURE.

### BRIEF DESCRIPTION OF THE FIGURE

FIG. 1 shows a schematic representation during the carrying out of the method in accordance with the present disclosure.

### DETAILED DESCRIPTION

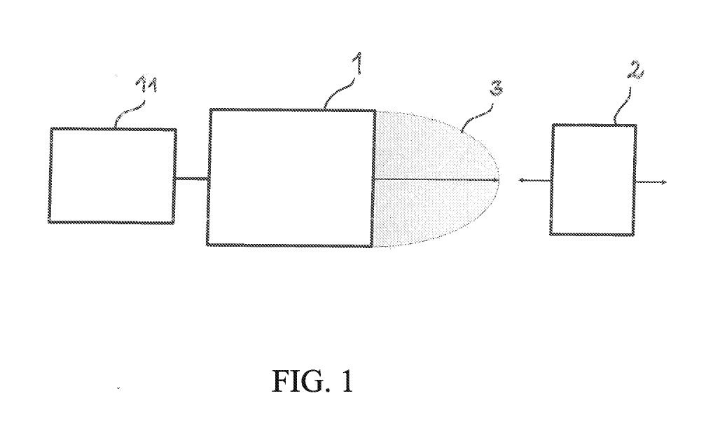

FIG. 1 shows an NFC reader/writer 1 that generates an electromagnetic field 3. A means is connected to the voltage regulation 11 in the form of the NFC reader/writer that readjusts the electromagnetic field 3 supplied with a constant voltage. An NFC tag 2 can furthermore be recognized that represents the passive radio communication unit. The arrows protruding from the NFC tag 2 stand for the spatial mobility of the NFC tag with respect to the NFC reader/writer 1 typically arranged as stationary. The arrow starting from the NFC reader/writer 1 is in this respect a representation for the propagation of the electromagnetic field 3.

The odometry over a short distance with the aid of NFC or also RFID takes place via the approach or the withdrawing of an antenna, here the NFC tag 2, to or from the NFC reader/writer 1.

In a first case, the distance between the NFC reader/writer 1 and the NFC tag 2 is determined on the side of the NFC reader/writer 1. In this respect, the NFC tag 2 or the consumer connected to the coil of the NFC tag 2 has a constant power consumption and influences the voltage value of the NFC reader/writer 1 on the entry into the electromagnetic field 3 to generate said field 3. It is possible to give a very exact FIGURE to the value to be readjusted by a readjustment of the voltage. The amount of the readjustment depends in this respect on the change of the distance between the NFC tag 2 and the NFC reader/writer 1.

It is possible in this respect, for example, that the voltage measurement on a change of the electromagnetic field 3 and the readjustment of the voltage value that may be necessary is carried out in a separate unit connected to the NFC reader/writer 1. The separate unit may be located remote from the NFC reader/writer 1. It is, however, also possible that the voltage regulation and the corresponding evaluation are carried out in the NFC reader/writer 1 itself. On a change of the voltage that results from the induction of the power into the NFC tag 2, the measurement of the distance is then started and can be presented continuously due to the value to be readjusted of the electromagnetic field 3 supplied with a constant voltage.

Alternatively or additionally, it is possible to carry out the measurement of the distance between the two radiation communication units 1, 2 via the passive radiation communication unit 2 (NFC tag or antenna of the NFC tag) that comprises a consumer. In this respect, the power induced over the magnetic field 3 is measured by a circuit or by a system and a conclusion is drawn on a specific distance between the two radiation communication units 1, 2 in dependence on the value.

The circuit or the system can in this respect also be disposed downstream with respect to the NFC tag 2, with a microcontroller (μC) being suitable in this respect. The induced electrical power or a value associated with the induced electrical power can also be measured. Such an electrical value varies in dependence on the proximity to the NFC reader/writer 1, with such a change being recorded and being able to be used for an information evaluation on the antenna side.

In this respect, the measurement range can be divided with a plurality of threshold values and a function linked with the range can be carried out in dependence on that region of the plurality of regions in which the measured value falls.

It is thereby possible to determine the distance of the NFC tag 2 from the NFC reader/writer 1 either on the side of the NFC reader/writer 1 or on the side of the NFC tag 2.

1. A method of determining a distance between an active radiation communication unit and a passive radiation communication unit comprising:
generating a constant electromagnetic field by the active radiation communication unit,
withdrawing power from the constant electromagnetic field through the passive radiation communication unit,
readjusting a control variable acting on the constant electromagnetic field in the active radiation communication unit on an entry of the passive radiation communication unit into the electromagnetic field, and
wherein the distance of the two radiation communication units from one another is determined with reference to the readjusted control variable.

2. The method in accordance with claim 1, wherein the passive radio communication unit has a constant or variable power consumption.

3. The method in accordance with claim 1, wherein the passive radio communication unit comprises an antenna for power consumption from the electromagnetic field.

4. The method in accordance with claim 1, wherein the induced power is measured and compared with at least one threshold value, and wherein the passive radio communication unit preferably carries out a function dependent on the comparison with the at least one threshold value.

5. The method in accordance with claim 4, wherein the measured power is compared with a plurality of threshold values dividing a power range and the passive radio communication unit carries out a function linked with the power range when the measured power is in the corresponding power range.

6. The method in accordance with claim 1, wherein the active radio communication unit generates an electromagnetic field having a constant voltage and said voltage is readjusted on an entry of the passive radio communication unit into the field such that the voltage regulation produces a value that continuously reproduces the distance between the two radio communication units.

7. The method in accordance with claim 1, wherein the readjusted voltage is measured and compared with at least one threshold value, and wherein the active radio communication unit preferably carries out a function dependent on the comparison with the at least one threshold value.

8. The method in accordance with claim 7, wherein the readjusted voltage is compared with a plurality of threshold values dividing a voltage range and the active radio communication unit carries out a function linked to a voltage range when the readjusted voltage is in the corresponding voltage range.

9. The method in accordance with claim 1, wherein the passive radio communication unit and the active radio communication unit can set up an NFC connection or an RFID connection between one another.

10. The method in accordance with claim 1, wherein the active radio communication unit is an NFC reader/writer and the passive radio communication unit is an NFC tag.

11. A method of actuating a door, comprising:
measuring a distance measurement between the two radio communication units in accordance with the method of claim 1, and
initiating the actuation of a door by the passive radio communication unit or the active radio communication unit when the measured distance falls below a specific distance threshold value.

12. A method in accordance with claim 11, wherein a downstream system associated with the active communication unit or the passive radio communication unit actuates the door.

13. The method in accordance with claim 12, wherein the downstream system is a radio module.

14. A method of determining a distance between an active radiation communication unit and a passive radiation communication unit, comprising:
generating a constant electromagnetic field wherein the constant electromagnetic field is generated by the active radiation communication unit,
detecting power induced over the electromagnetic field of the passive radiation communication unit on entry of the passive radiation communication unit into the electromagnetic field,
wherein the power induced over the electromagnetic field of the passive radiation communication unit is detected by the passive radiation unit, and
wherein the distance of the two radiation communication units from one another is determined with reference to the induced power.

15. The method in accordance with claim 14, wherein the passive radio communication unit has a constant or variable power consumption.

16. The method in accordance with claim 14, wherein the passive radio communication unit comprises an antenna for power consumption from the electromagnetic field.

17. The method in accordance with claim 14, wherein the induced power is measured and compared with at least one threshold value, and wherein the passive radio communication unit preferably carries out a function dependent on the comparison with the at least one threshold value.

18. The method in accordance with claim 14, wherein the active radio communication unit generates an electromagnetic field having a constant voltage and said voltage is readjusted on an entry of the passive radio communication unit into the field such that the voltage regulation produces a value that continuously reproduces the distance between the two radio communication units.

19. The method in accordance with claim 14, wherein the readjusted voltage is measured and compared with at least one threshold value, and wherein the active radio communication unit preferably carries out a function dependent on the comparison with the at least one threshold value.
